(19) United States
(12) Patent Application Publication
(10) Pub. No.: US 2025/0323332 A1
(43) Pub. Date: Oct. 16, 2025

(54) ENHANCED FAST CHARGING AND LOW-TEMPERATURE OPERATION FOR LITHIUM-ION BATTERIES USING BULK CURRENT INJECTION

(71) Applicants: Jonghyun Park, Rolla, MO (US); Chulsoon Hwang, Rolla, MO (US); Emmanuel Olugbade, Rolla, MO (US); Obringer Ndodjim, Rolla, MO (US); Hanyu Zhang, Columbia, MO (US)

(72) Inventors: Jonghyun Park, Rolla, MO (US); Chulsoon Hwang, Rolla, MO (US); Emmanuel Olugbade, Rolla, MO (US); Obringer Ndodjim, Rolla, MO (US); Hanyu Zhang, Columbia, MO (US)

(73) Assignee: The Curators of the University of Missouri, Columbia, MO (US)

(21) Appl. No.: 19/178,213

(22) Filed: Apr. 14, 2025

Related U.S. Application Data
(60) Provisional application No. 63/633,508, filed on Apr. 12, 2024.

(51) Int. Cl. H01M 10/44; H01M 10/0525; H01M 10/46; H02J 7/04

(52) U.S. Cl. CPC H01M 10/443; H01M 10/0525; H01M 10/46; H02J 7/04; H01M 2220/20

(57) ABSTRACT

Systems and methods for improved fast-charging and low-temperature charging of batteries. For fast-charging applications, bulk-current injection is applied in bursts during charging to promote ion mobility therein. For low-temperature charging applications, bulk-current injection is applied for an extended period of time to warm the battery through internal resistance. Systems configured to provide bulk-current injection to a battery are also described. The system includes an alternating current source, a direct current source, a battery to be charged, and a battery management system (BMS) configured to selectively engage and disengage the power sources to optimally charge the battery using bulk-current injection.

### CROSS-REFERENCE TO RELATED APPLICATION

This application claims priority to U.S. Provisional Patent Application No. 63/633,508, filed Apr. 12, 2024, the entire disclosure of which is incorporated herein by reference.

### STATEMENT OF GOVERNMENT SUPPORT

This invention was made with government support under Grant No. 2028992 awarded by the National Science Foundation. The government has certain rights in the invention.

### FIELD

Provided herein are methods and systems for battery charging. Also provided herein are methods and systems for controlling the temperature of a battery. Additionally, provided herein are methods and systems for fast charging and low temperature charging of lithium-ion batteries utilizing bulk-current injection.

### BACKGROUND

Lithium plating poses a significant issue with respect to battery integrity and performance. Lithium plating occurs during battery charging, when lithium ions (L⁺) deposit as metallic lithium on the anode of the battery rather than intercalating into the electrode. Lithium plating is typically observed when charging a battery at a high state-of-charge (SoC) level (e.g., above 80%). Lithium plating may also be observed when seeking to “fast charge” a battery (e.g., at a high C-rate). The presence of lithium plating leads to capacity loss, increased internal resistance, and, in extreme cases, internal short circuits which compromise battery safety. Conventional strategies for addressing lithium plating involve modifying electrode materials or implementing complex charge protocols, but these approaches either require changes to battery chemistry or introduce trade-offs in charging speed.

Further problems are encountered when attempting to charge batteries at low temperatures. At sub-zero temperatures, lithium-ion batteries experience significantly reduced ionic conductivity and increased internal impedance, which leads to poor charge acceptance, reduced capacity, and even complete charging failure. Conventional methods typically rely on external heating systems to warm the battery before charging, but these solutions are energy-intensive, bulky, and impractical for many applications, particularly for portable devices and electric vehicles.

Therefore, a need exists for new and improved methods and systems for charging a battery that reduce or mitigate lithium plating. A need also exists for new and improved methods and systems for charging a battery at low temperatures that improves the energy efficiency and/or design requirements for charging at such conditions.

### SUMMARY

One aspect of the present disclosure is directed to a method of charging a lithium-ion battery. The method comprises providing a source of power comprising direct current to the lithium-ion battery; providing a bulk-current to the lithium-ion battery; and charging the lithium-ion battery from a first state-of-charge level to a final state-of-charge level. Providing the source of power increases the state-of-charge of the lithium-ion battery. The bulk-current is an alternating current.

Further aspects of the present disclosure are directed to a method of charging a lithium-ion battery in a low-temperature environment. The method comprises providing the lithium-ion battery having a first state-of-charge level and a first temperature level; providing a bulk-current to the lithium-ion battery to increase the temperature of the lithium-ion battery from the first temperature level to a second temperature level; and providing a source of power comprising direct current to the lithium-ion battery. The bulk-current is an alternating current. Providing the source of power increases the state-of-charge of the lithium-ion battery from a first state-of-charge level to a final state-of-charge level.

Still further aspects of the present disclosure are directed to a lithium-ion battery charging system. The system comprises a lithium-ion battery having an anode and a cathode; an alternating current power source configured to provide a bulk-current to the anode of the lithium-ion battery; and a direct current power source configured to charge the battery from a first state-of-charge level to a final state-of-charge level.

Other objects and features will be in part apparent and in part pointed out hereinafter.

### BRIEF DESCRIPTION OF THE DRAWINGS

FIG. 1 is a flow chart of a battery charging method according to an embodiment.

FIG. 2 is a flow chart of a battery charging method according to an embodiment.

FIG. 3A is a graph showing application of bulk-current injection to a CC-CV charging modality.

FIG. 3B is a graph showing application of bulk-current injection to a MCC-CV charging modality.

FIG. 4 is a flow chart of a battery charging method according to one embodiment.

FIG. 5 shows a laboratory setup for BCI injection to a battery.

FIG. 6 is a schematic of a BCI circuit shown in FIG. 5.

FIGS. 7A and 7B are graphs showing voltage output as a function of frequency and voltage input, respectively.

FIG. 8 is a graph showing specific capacity as a function of battery cycle for a battery charged with and without bulk-current injection.

FIG. 9A is similar to FIG. 8, but includes multiple batteries.

FIG. 9B is a graph showing temperature as a function of battery cycle for the batteries of FIG. 9A.

FIG. 10 is a graph showing voltage as a function of time for a battery charged according to an embodiment.

Corresponding reference characters indicate corresponding parts throughout the drawings.

### DETAILED DESCRIPTION

It is a goal of the industry to improve the speed of charging of batteries. However, it is not feasible to decrease charging times for lithium-ion batteries by simply increasing the current delivered thereto. Many electrochemical and safety limitations are encountered when such an increase in current is attempted. For example, when current is increased beyond the battery's safe charging rate, lithium ions may accumulate on the anode surface faster than they can intercalate into the graphite. This leads to lithium plating, where metallic lithium deposits form on the anode. Lithium plating may result in reduced battery capacity, increased internal resistance, and increasing the risk of dendrite formation. Dendrites can puncture the separator, causing short circuits and potentially triggering thermal runaway or fire. In certain situations, higher currents generate more heat in the battery, which accelerates the degradation of the electrolyte and other battery components, shortening the battery's lifespan. Excessive current also increases internal resistance and voltage drop, reducing the battery's overall efficiency. In extreme cases, excessive current may result in internal short circuits that compromise battery safety.

To safely facilitate faster charging times while preventing lithium deposition on the anode (i.e. lithium plating), increased lithium-ion mobility (e.g., for improved intercalation) is needed.

Most fast-charging strategies in the industry rely on constant current-constant voltage (CC-CV) charging protocols or pulsed current techniques, which are designed to lower overpotential at the anode and slow down lithium plating. However, these approaches are passive and only adjust charging parameters rather than directly modifying lithium-ion transport dynamics.

Certain embodiments of the present disclosure are directed to methods and systems for charging a lithium-ion battery comprising providing a source of power to increase the state-of-charge of the lithium ion battery and a bulk-current. As described elsewhere herein, the inventors have surprisingly discovered that a bulk-current may be used to alter the lithium-ion transport dynamics present during charging, and prevent or reduce lithium plating that may occur during the charging. In aspects described herein, the inventors have surprisingly discovered that a bulk-current may also be used to introduce a self-heating effect by leveraging the internal impedance of the battery. This heating via a bulk-current may be especially useful for low-temperature charging applications.

The present disclosure is directed in one embodiment to charging methods comprising injection of a bulk-current to the battery. Bulk-current injection (BCI) is presently used as an electromagnetic compatibility (EMC) testing method to evaluate a device's immunity to conducted radio frequency disturbances. The testing method entails injecting a controlled radio frequency current into the cables or wiring harnesses of a device under test. The test assesses whether the device can function properly when exposed to radio frequency interference. BCI is also used in automotive, aerospace, military, and industrial EMC testing to simulate real-world electromagnetic interference conditions.

Within the context of the present disclosure, however, the bulk-current injection is not used to refer to the testing method explained above. Instead, the present disclosure is directed in certain embodiments to the injection of a bulk-current into the battery before, during, and/or after the charging of the battery to promote lithium ion mobility therein. In some embodiments, the bulk-current is a high frequency (e.g., from about 1 to about 10 MHz) alternating current. The injection of this bulk-current may be employed over extended periods of time. In other embodiments, the bulk-current may be injected in short bursts, whether isolated or successive in nature.

As noted above, in fast charging scenarios, lithium plating presents a major degradation mechanism, particularly at elevated state-of-charge (SoC) levels. At an SoC of about 80%, lithium plating becomes a significant risk. Lithium plating occurs at an SoC of around 80% primarily due to the decreased potential and reduced lithium ion diffusion at and/or within the anode (e.g., graphite of the anode). As the battery charges, the anode potential approaches the lithium intercalation limit, especially at high charging rates. At an SoC of about 80%, the graphite anode is nearly (e.g., approximately, almost) saturated with lithium ions, making intercalation more difficult and significantly slower. This leads to a higher local concentration of lithium ions at the surface of the anode (e.g., plating).

The inventors have surprisingly discovered that applying a bulk-current (e.g., high-frequency AC signal) at this stage induces electrochemical interactions which alter lithium-ion transport dynamics. This is observed as a voltage dip (e.g., a temporary reduction in potential) in the charge profile at the anode. This real-time response resulting from the application of a bulk-current reduces localized overpotential, effectively suppressing lithium deposition (e.g., lithium plating) while maintaining high charge rates.

The deployment of BCI as a practical enhancement for lithium-ion batteries offers significant benefits in fast charging and low-temperature operation. BCI's potential to mitigate lithium plating and improve charge acceptance has not been leveraged in commercial battery applications. The present disclosure is directed in certain embodiments to the optimized application of BCI to address key performance challenges in lithium-ion batteries, particularly at high SoC and low temperatures. In some embodiments, BCI is strategically applied at high SoC (e.g., 80% or greater) and actively influences lithium-ion transport, inducing an immediate electrochemical response that stabilizes charge acceptance and suppresses degradation without slowing down the charging rate.

Cells cycled with BCI exhibit higher specific capacity retention (e.g., improved electrochemical performance) and improved cycle life, demonstrating its effectiveness as a practical strategy for mitigating degradation without altering battery chemistry.

To ensure thermal stability and prevent excessive heat buildup, the exposure time of BCI (e.g., the duration of a BCI burst/injection) is specifically tailored (e.g., limited to one minute). This maximizes performance gains without increasing thermal stress on the battery.

Conventional lithium-ion batteries also typically suffer from electrolyte freezing and increased internal resistance when present at low temperatures (e.g., −10° C.). Therefore, external heating systems are typically employed to heat (or maintain the temperature of) the battery to an elevated temperature prior to charging.

Certain further embodiments of the present disclosure are directed to the application of a bulk-current as an aid to lithium-ion battery charging at low temperatures. For low-temperature charging, the bulk-current introduces a self-heating effect by leveraging the internal resistance of the battery (as described in further detail herein). The controlled temperature rise from this bulk-current injection enhances ionic conductivity within the electrolyte, thereby facilitating faster lithium transport. This renders external heating systems, and the resulting equipment space/cost unnecessary. Unlike conventional thermal management solutions that rely on resistive heating elements or phase-change materials, the present disclosure's bulk-current resistive/impedance-induced heating offers a non-intrusive, energy-efficient approach which may be integrated into existing battery management systems (BMS).

As will be further described below, standard charging (e.g., using a DC power supply) and the application of a bulk-current may be performed simultaneously, in succession, or in any combination/variation thereof. For example, an alternating current (i.e. bulk-current) may be superimposed onto a DC current to create an oscillating waveform at a positive voltage.

In one embodiment, the bulk-current is provided as a plurality of discrete injection (e.g., each over a limited period of time, such as 1 minute) throughout the charging process. In some embodiments, during an injection, charging of the battery with the direct current is temporarily suspended until completion of the injection. Overlap of standard charging and BCI may be employed to any degree and to varying effect. For example, there may be no overlap, wherein standard charging is performed only after complete cessation of BCI, and/or wherein BCI is performed only after complete cessation of BCI. In other embodiments, there may be a partial overlap, wherein standard charging is performed for a limited (e.g., finite) period of time after cessation of BCI, and/or wherein BCI is performed for a limited period of time after cessation of standard charging. Successive BCI injections may be performed using any variation of the protocols described above and below (e.g., with no overlap, with a partial overlap, simultaneously, etc.).

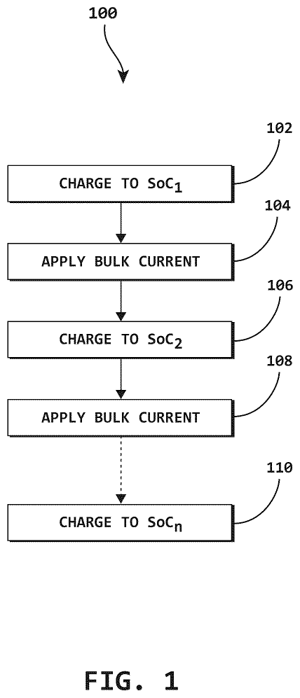

Referring to FIG. 1, an exemplary embodiment for charging a battery in accordance with one embodiment of the present disclosure is shown at reference number 100. The method 100 comprises charging a battery to a first state of charge (SoC₁), applying a bulk-current injection to the battery, and charging the battery to a second state of charge (SoC₂). By introducing a bulk-current during charging, lithium ion mobility is increased, facilitating ion intercalation at the anode. In this way, lithium plating and its effects are minimized. As will be explained in further detail below, the method allows fast charging with reduced lithium ion deposition at the anode.

At operation 102, a battery is charged to a first SoC (e.g., SoC₁). In exemplary embodiments, the first SoC is an elevated SoC (e.g., 70%, 80%, 3.0 V, 3.5 V, etc.) at which the risk of lithium plating is higher. The battery may be charged to SoC₁ using any number of existing charging modalities. For example, constant current-constant voltage (CC-CV), constant power-constant voltage (CP-CV), multistage constant current (MCC), and any combination thereof. Depending on the initial SoC for the battery, the time to charge the battery to SoC₁ may vary. For example, considering a battery which is fully or near fully depleted, charging the battery to SoC₁ may take between thirty minutes to several hours. Additional factors, such as the charging current, temperature, and battery age (e.g., the number of charge-and-deplete cycles experienced throughout the batteries lifetime) may affect the charging period from the initial SoC to SoC₁. Because lithium plating occurs disproportionately at elevated SoC's, SoC₁ may be an elevated SoC (e.g., >50%).

At operation 104, a bulk-current is injected into the battery. The bulk-current may be provided via voltage modulation of a power supply or through current modulation of a current source. If the bulk-current is superimposed over an existing direct current (e.g., a charging current present from operation 102, 106, etc.), the battery may continue to charge while undergoing bulk-current injection.

At operation 106, the battery is charged to a second SoC (e.g., SoC₂). Like operation 102, SoC₂ may be reached using any number of existing charging modalities, such as CC-CV, CP-CV, MCC, etc.

At operation 108, a bulk-current is injected again. In certain embodiments, operation 108 may be performed identically to operation 104. In other embodiments, the characteristics of the injection may be varied from those of 104 for improved efficacy (e.g., frequency, duration, etc.).

The operations of method 100 continue in this way (e.g., charging-BCI-charging BCI-charging BCI-etc.) until the battery reaches a final SoC.

At operation 110, the battery is charged to a final n^{th} SoC (e.g., SoCₙ). In certain embodiments, operation 110 may be performed identically to operations 102 or 106. In other embodiments, the characteristics of the charging may be varied from operations 102 or 106 for improved efficacy.

In one embodiment, operation 110 is the final operation of the method, and results in a full or near-full charge of the battery (i.e., SoCₙ≈100%).

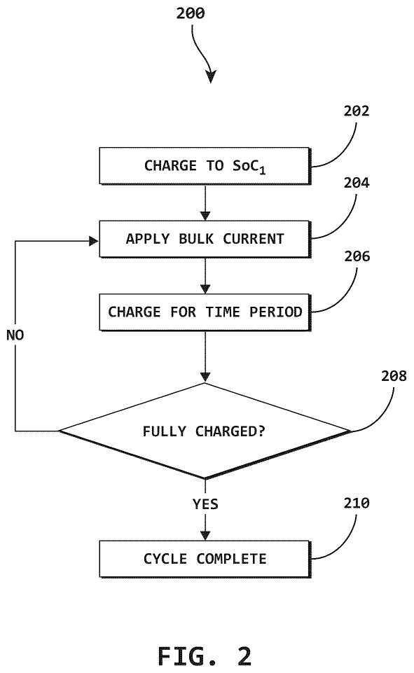

Referring now to FIG. 2, another embodiment of a method for charging a battery is shown in the form of a flow chart, and is indicated as method 200. Method 200 is similar to method 100 illustrated in FIG. 1. However, the application of the bulk-current in method 200 is time dependent as opposed to SoC dependent.

At operation 202, a battery is charged to a first SoC (e.g., SoC₁). Because lithium plating occurs disproportionately at high SoC's, SoC₁ may be an elevated SoC (e.g., >50%). In exemplary embodiments, SoC₁ is an elevated SoC corresponding to an increased risk of lithium plating (e.g., 70%, 80%, 3.0 V, 3.5 V, etc.). The battery may be charged to SoC₁ using any number of existing charging modalities, such as CC-CV, CP-CV, MCC, etc. Depending on an initial SoC for the battery (e.g., ≈0%, ≈0V), the time to charge the battery to SoC₁ may vary. For example, considering a battery which is fully or near fully depleted, charging the battery to SoC₁ may take between thirty minutes to several hours. Additional factors, such as the charging current, temperature, and battery age (e.g., the number of charge-and-deplete cycles experienced throughout the batteries lifetime) may affect the charging period from the initial SoC to SoC₁.

At operation 204, a bulk-current is applied to the battery. The bulk-current may be provided via voltage modulation of a power supply or through current modulation of a current source. If the bulk-current is superimposed over an existing direct current (e.g., a charging current present from operation 202), the battery may continue to charge while undergoing BCI.

At operation 206, the battery is charged for a defined period of time. The period of time may be any suitable period determined by the operator. This period of time may vary in different contexts (e.g., depending on the chemistry of the battery and the conditions in which charging is occurring).

At operation 208, the SoC of the battery is measured and compared to full charge SoC (e.g., wherein the full charge SoC is at approximately 100%). The SoC of the battery is approximated by measuring the voltage across the terminals thereof (e.g., between the cathode and the anode). This may be performed, for example, by a microcontroller as part of a battery management system. If the battery is fully charged, the cycle is complete and charging is terminated at operation 210. If the battery is not fully charged, operations 204 and 206 are repeated until operation 208 yields a determination of full charge. Operations 204 and 206 may be the same or different during these repeated instances. For example, the duration of the charge applied after the BCI may be increased with each successive charge (i.e., with each repetition of operation 206).

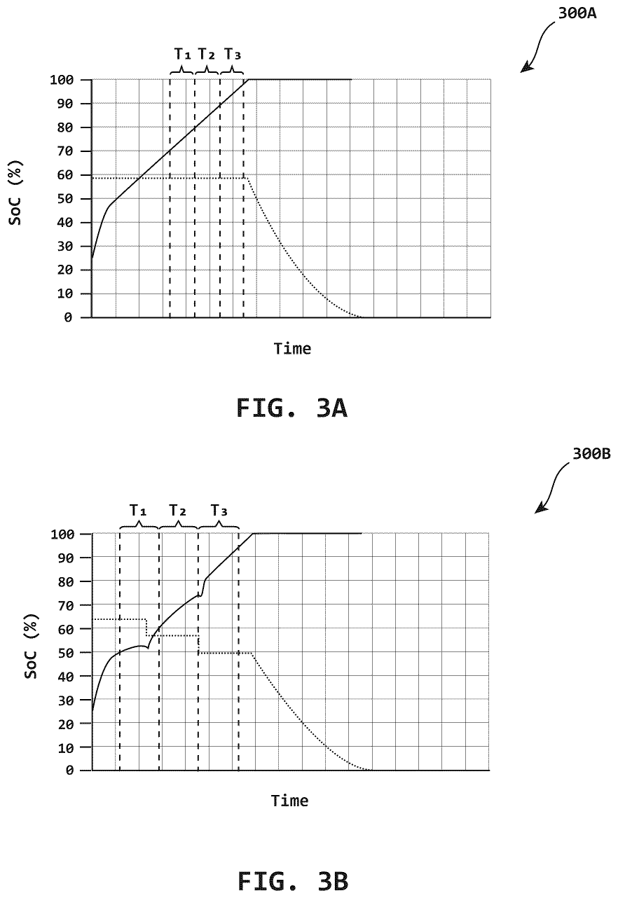

Referring now to FIGS. 3A and 3B, the method 200 is shown in alternative charging modalities. At graph 300A, the method 200 is shown being employed in a CC-CV charging modality, with a SoC₁ (i.e. at the initial time T1) of 70%. At graph 300B, the method 200 is shown being employed in a MCC-CV charging modality with a SoC₁ of 50%. For both of graphs 300A and 300B, after being charged to SoC₁, multiple bulk-current injections are performed in succession across time intervals T1, T2, and T3. While the time intervals T1, T2, T3 shown at graphs 300A and 300B are uniform, in alternative implementations of the method 200 the time intervals may vary.

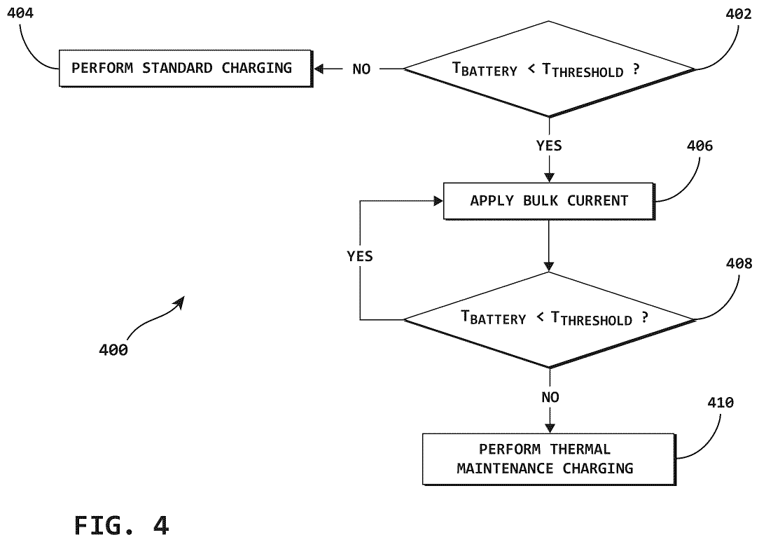

Referring to FIG. 4, a method for low-temperature charging according to one embodiment of the present disclosure is shown in the form of a flow-chart, and is indicated as method 400. The method is directed to pre-heating a battery (e.g., prior to charging) such that subsequent charging thereof is both safer and more effective. When the temperature of a battery is low (e.g., below freezing), ion mobility is significantly reduced, leading to deficits in intercalation at the anode. As a result, regular charging operations (e.g., at a standard voltage) are insufficient for adequately charging the battery.

At operation 402, the temperature of the battery is measured and compared to a threshold temperature. The battery temperature may be measured using any number of devices, for example a thermocouple or a thermal imaging device.

The threshold temperature is a predetermined value representing the temperature below which the battery is considered to be subject to the described low-temperature charging operations. For example, the threshold temperature may be freezing (e.g., 32° F., 0° C.).

If the battery temperature is determined to be greater than the threshold temperature (e.g., if the temperature of the battery is not below freezing), the method proceeds to operation 404, wherein the battery is charged according to standard charging protocols (e.g., charging modalities for room-temperature charging or as described in FIGS. 1 and 2 above). In certain embodiments, the standard charging protocols may comprise the bulk-current methods described herein to minimize lithium plating.

If, however, the battery temperature is determined to be less than the threshold temperature (e.g., if the temperature of the battery is below freezing), the method proceeds to operation 406.

At operation 406, a bulk-current is injected to the battery. The bulk-current may be provided via voltage modulation of a power supply or through current modulation of a current source.

In certain embodiments, one purpose of the bulk-current of operation 406 is to warm the battery through its own internal resistance (e.g., impedance) and promote ion mobility and intercalation. Every battery has an internal resistance which generates ohmic heating. By applying bulk-current to the battery at low-temperatures, these phenomena are leveraged to warm the battery without requiring an exterior heat source. In an exemplary embodiment, the bulk-current is applied at a frequency of approximately 25 MHz, and at a voltage Vᵣₘₛ (i.e., root mean squared voltage) of approximately 700 mV. Vᵣₘₛ as used herein is a measure of the effective voltage of an alternating current (AC) waveform. It represents the equivalent direct current (DC) voltage that would deliver the same power to a resistive load. Since AC voltages vary over time, Vᵣₘₛ provides a practical way to quantify the average power delivery capability. For a sinusoidal waveform, Vᵣₘₛ is equal to the peak voltage (Vₚₑₐₖ) divided by the square root of 2 (e.g., approximately 0.707×Vₚₑₐₖ). This value directly corresponds to the power dissipation in resistive components.

In various embodiments, the bulk-current is applied for a specified period of time (e.g., a heating period longer than one minute). Prolonged exposure to the bulk-current at such initially low temperatures generally provides the battery adequate time to warm up without jeopardizing safety. However, certain embodiments are directed to use of a specific heating period to avoid overheating of the battery. The heating period may be predetermined (e.g., static, fixed), but may also be determined independently (e.g., dynamically adjusted) for each recitation of the method 400. For example, the heating period may be determined as a function of the initial temperature of the battery, wherein a lower initial temperature (e.g., −10° F.) corresponds to a longer heating period (e.g., 15 minutes) and a higher initial temperature (e.g., 30° F.) corresponds to a shorter heating period (e.g., 5 minutes). Other characteristics of the bulk-current, including the frequency and voltage, may also be dynamically adjusted as function of the battery charging environment.

At operation 408, the temperature of the battery is again measured and compared to the threshold temperature. This operation may be performed identically to operation 402. If the heating period of operation 406 was applied for a set amount of time (e.g., 5 minutes), then operation 408 is performed directly following the expiration of the heating period. Additionally, operation 408 may be performed concurrently with operation 406. For example, if operation 406 is performed such that the heating period is dynamically adjusted, operation 408 may be performed concurrently with operation 406 such that operation 406 is performed until operation 408 determines that the temperature of the battery is greater than the threshold temperature. If it is determined at operation 408 that the battery temperature is greater than the threshold temperature, operation 410 is performed. In certain embodiments, an alternative (e.g., elevated) threshold temperature is used at operation 408. That is, the threshold temperature required to determine whether to enact the method of 400 (i.e. at step 402) may be the same or different from the temperature used in operation 408 to determine if the method may proceed to operation 410. For example, a battery being charged from below a freezing threshold temperature of 0° C. may be subjected to the warming steps and not proceed to operation 410 until it has achieved a temperature of 20° C.-22° C. (i.e. room temperature).

At operation 410, thermal maintenance charging is performed. Thermal maintenance charging is a charging modality configured to maintain the battery temperature at or above a maintenance temperature. In certain embodiments, the maintenance temperature is the same as the threshold temperature of both or either of operations 402 or 408. To maintain the battery temperature at or above the maintenance temperature, a bulk-current is superimposed on top of a direct current (e.g., a charging current) such that continued excitation of lithium ions occurs throughout charging. In certain embodiments, this bulk charge is referred to as the thermal maintenance bulk-current.

In various embodiments described herein, the bulk-current is an alternating current. In one embodiment, the alternating current is a sinusoidal high-frequency current. In certain embodiments described herein, the bulk-current is provided to the anode of the lithium-ion battery.

In some embodiments, the bulk-current is low-frequency. In other embodiments, the bulk-current is a high frequency. Within the context of the present disclosure, the term “low-frequency” may be used to refer to frequencies from about 1 Hz to about 1 MHz, and the term “high-frequency” may be used to refer to frequencies of about 1 MHz or greater.

In other embodiments, the bulk-current described herein has a frequency that is from about 1 Hz to about 100 Hz, from about 100 Hz to 1 kHz, from about 1 kHz to about 100 kHz, from about 100 kHz to about 1 MHz, from about 1 MHz to about 10 MHz, or from about 10 MHz to about 100 MHz. In other embodiments, the bulk-current has a frequency greater than about 100 MHz. In certain embodiments, the bulk-current described herein has a frequency that is about 25 MHz.

It will be understood that discussion herein directed to selection of a suitable frequency may be limited by the underlying power source. That is, the frequency employed may be limited by the availability of power on the grid or the devices used to transmit and transform the electrical energy. In certain embodiments, a power converter or other electronic components may be utilized to adjust the frequency of the voltage and/or current.

In certain embodiments, the bulk-current described herein has a voltage that is from about 100 mV to about 1000 mV, from about 200 mV to about 1000 mV, from about 300 mV to about 1000 mV, from about 400 mV to about 1000 mV, from about 500 mV to about 1000 mV, from about 500 mV to about 900 mV, from 500 mV to about 800 mV, or from 600 mV to about 800 mV.

In some embodiments, the bulk-current described herein has a voltage of about 700 mV and frequency of about 25 MHz.

In certain embodiments, the source of power described herein comprises a DC power supply. In other embodiments, the source of power is a direct current.

It will be understood that the ordering of any of the described methods and systems may be changed and be within the scope of the present disclosure. In various embodiments comprising charging (e.g., providing a source of power) and bulk-current injection (i.e. providing a bulk current), the charging and bulk current injection steps may be performed simultaneously, overlap, or occur in succession. Further, the methods and systems described herein may comprise one or more (e.g., a plurality) of charging or bulk-current injection steps in any order.

In one embodiment, a method of charging a lithium-ion battery comprises charging, followed by bulk current injection, followed by further charging. In another embodiment, a method of charging a lithium-ion battery comprises charging, an overlapping period of bulk current injection, and further charging at the conclusion of the bulk current injection. In still a further embodiment, a method of charging a lithium-ion battery comprises continuously charging and intermittently performing bulk current injections. In one embodiment, an alternating current (i.e. bulk-current) may be superimposed onto a DC current to create an oscillating waveform at a positive voltage.

As discussed elsewhere herein, application of a bulk-current may contribute to an increase in the temperature of the battery. Therefore, in some embodiments, it may be desirable that the bulk-current is applied for a discrete period of time and then stopped. For example, for a period of about five minutes or less, about four minutes or less, about three minutes or less, about two minutes or less, about one minute or less, or about 30 seconds or less.

In other embodiments, a waiting period may be observed between applications of bulk-current. For example, in one embodiment, a plurality of bulk-current injections are provided to the battery and the waiting period between each injection of the plurality of injections is about 30 second or more, about one minute or more, about 2 minutes or more, about 3 minutes or more, about 4 minutes or more, about 5 minutes or more, about 10 minutes or more, about 20 minutes or more, or about 30 minutes or more.

Characteristics of the bulk-current (e.g., voltage, frequency) or charging current may be dynamically adjusted as a function of measured environmental conditions (e.g., battery temperature, ambient temperature, SoC, etc.). For example, it may be determined that the battery is experiencing thermal runaway during operation of any of the described methods. Thermal runaway is used herein to refer to a self-reinforcing cycle in which an increase in temperature results in further heating. With respect to batteries, thermal runaway occurs when internal heat generation surpasses the batteries ability to dissipate it. This may be caused by overcharging, internal short circuits (e.g., between an anode and a cathode via a damaged electrolyte or via battery terminals), physical damage (e.g., puncture, bending, compression, etc.), or exposure to high temperatures. As the battery heats up, the electrolyte may decompose, allowing electrons to pass directly from the anode to the cathode (as opposed to traveling from the anode to the cathode through a load). This can cause the battery to combust.

In certain embodiments, following a determination that the battery is experiencing a thermal runaway during performance, the bulk-current injection may be reduced in order to mitigate excess battery temperatures which may compromise battery integrity.

Certain embodiments herein are directed to charging of a battery in a low temperature environment. In some of these embodiments, the first temperature level of the battery (i.e. before application of a bulk-current or charging) may be about 0° C. or less, about −10° C. or less, about −20° C. or less, about −30° C. or less, or about −40° C. or less. In some embodiments, the second temperature level (i.e. temperature after application of a bulk-current and/or charging) is about 0° C. or greater, about 5° C. or greater, about 10° C. or greater, about 15° C. or greater, about 20° C. or greater, about 25° C. or greater, or about 30° C. or greater.

In various embodiments, a thermal maintenance bulk-current may be provided to the battery to maintain the temperature close to a desired temperature for charging (e.g., the second temperature level). In one embodiment, a thermal maintenance bulk-current may be provided to the battery to maintain the temperature within about ±10° C. or less, about ±5° C. or less, about ±4° C. or less, about ±3° C. or less, about ±2° C. or less, or about ±1° C. or less of the second temperature level.

In some embodiments, it may be determined that the battery temperature is falling despite application of a bulk-current. As a result, the bulk-current may be enhanced (e.g., increased) in order to prevent further battery temperature decline.

Certain methods herein are directed to charging a lithium-ion battery such that there is a reduced amount of lithium deposition at the anode of the battery. That is, the method results in less lithium deposition than a comparable method of charging which does not utilize bulk current injection. For example, in one embodiment, the first state-of-charge level of the lithium-ion battery is about 90% or less, the final state-of-charge level is about 90% or greater, and, after the battery is charged from the first state-of-charge level to the final state-of-charge level, the battery comprises a lower concentration of lithium deposition at the anode of the battery than an identical method wherein a bulk-current is not provided to the lithium-ion battery.

While discussion herein is primarily directed to lithium-ion batteries, it will be understood that the methods and systems described herein may be equally applicable to all batteries. One advantage of the above-described methods and systems is that they do not require fundamental changes to battery materials. Many existing battery performance improvements depend on new electrode chemistries, solid electrolytes, or electrolyte additives, which come with high material costs, complex manufacturing requirements, and long-term validation challenges before commercial adoption. BCI bypasses these limitations entirely by working with existing lithium-ion battery designs and can be seamlessly integrated into BMS via firmware/software updates. This allows for immediate, cost-effective implementation of fast-charging and low-temperature performance enhancements without disrupting existing manufacturing processes.

Where discussion herein is directed to a first SoC and final SoC, it will be understood that any intervening SoC may exist or be present. For example, a first SoC followed by a second SoC, followed by a third SoC, followed by a final SoC.

Where discussion herein is directed to a first temperature and final temperature, it will be understood that intervening temperature levels may exist or be present. For example, a first temperature followed by a second temperature, followed by a third temperature, followed by a final temperature.

Further embodiments are directed to a lithium-ion battery charging system. The system comprises a lithium-ion battery having an anode and a cathode, an alternating current power source configured to provide a bulk-current to the anode of the lithium-ion battery, and a direct current power source configured to charge the battery from a first state-of-charge level to a final state-of-charge level. In certain embodiments, the system operates in accordance with the methods and processes described herein.

In one embodiment, the lithium-ion battery charging system comprises a signal generator that produces a high-frequency sinusoidal waveform, which is then amplified by a power amplifier before being injected into the battery. To prevent unwanted DC bias or ground loops, in some embodiments, a transformer is used to isolate the amplifier from the battery, allowing only the intended AC signal to reach the cell. This isolation eliminates parasitic currents and ensures that any temperature increase within the battery is a result of internal impedance effects rather than external circuit heating. Additionally, the transformer assists in impedance matching, which improves the efficiency of current injection and minimizes energy losses during operation. This system further ensures that BCI deployment does not introduce unintended thermal stress or electrical disturbances within the battery system.

In some embodiments, the battery charging system may further comprise a battery management system (BMS) configured to selectively engage and disengage the alternating current power source and/or the direct current power source during the charging. Advantageously, bulk-current described herein may be seamlessly integrated into existing BMS through firmware or software updates, allowing for immediate, cost-effective implementation without requiring major design changes.

In certain embodiments, the batteries described herein may be vehicle batteries. In one embodiment, the vehicle battery is an electric vehicle battery. In other embodiments, the described methods and systems may be applied or used in connection with aerospace applications, consumer electronics, and/or grid storage systems.

In the electric vehicle and energy storage sectors, the trade-off between fast charging and battery longevity has been a persistent challenge. Conventional fast-charging methods accelerate degradation, requiring manufacturers to compensate with larger battery packs or additional thermal management measures to extend lifespan. The optimized deployment of bulk-current described herein breaks this cycle by offering a technique that enhances both fast-charging efficiency and long-term battery health, reducing the need for costly design modifications or compromises between speed and durability. By focusing on practical implementation, scalability, and real-world validation, this work establishes bulk-current as a readily deployable solution for improving lithium-ion battery performance in next-generation energy storage systems.

Further, unlike conventional approaches that passively adjust charge profiles or rely on material modifications, bulk-current methods described herein actively interact with the electrochemical environment of the battery by injecting a controlled high-frequency AC signal. This targeted intervention optimizes lithium-ion transport, mitigates lithium plating, and enhances charge acceptance, leading to improved cycle life and reduced degradation.

### EXAMPLES

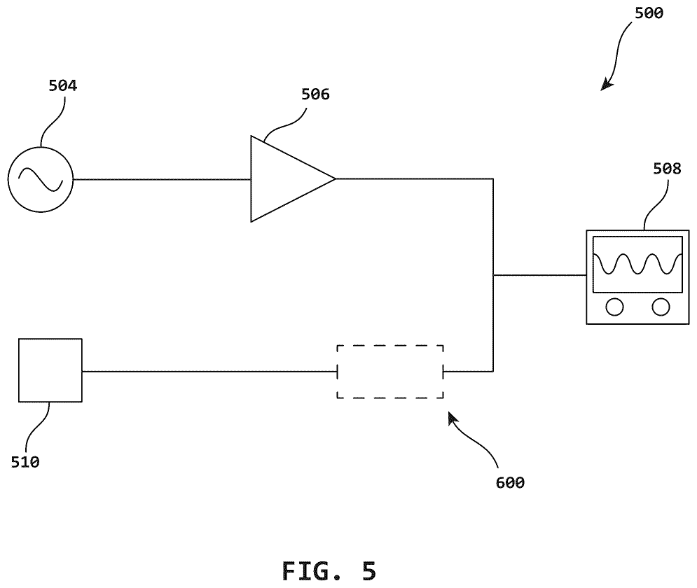

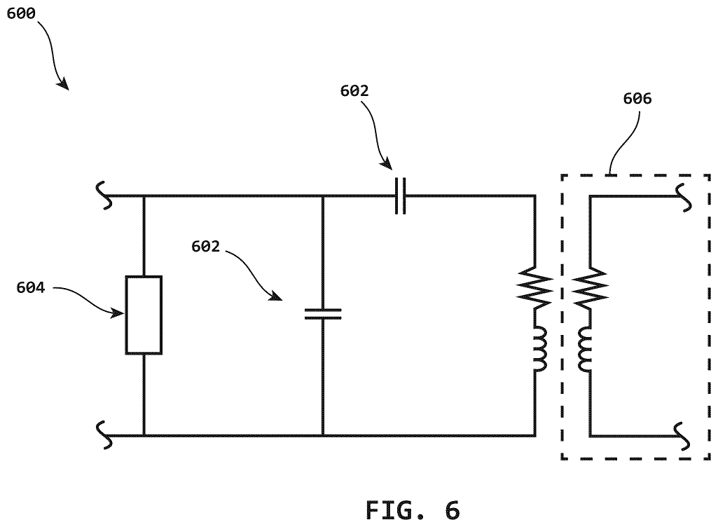

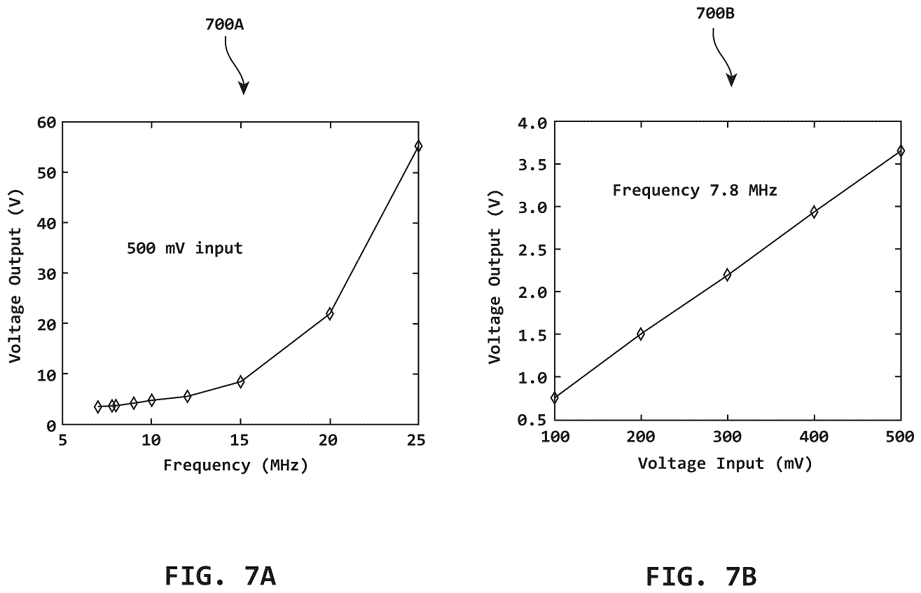

Certain experiments were conducted using one or more of the embodiments discussed herein. Experimental equipment setup is shown in FIGS. 5 and 6 and data is reported in FIGS. 7A-10. The data demonstrates the effect of the methods of the present disclosure on charge rate, specific capacity, and temperature for multiple batteries under test.

### Example 1

In a first example, a bulk current injection apparatus was designed.

FIG. 5 shows the setup 500 for a bulk current injection (BCI) circuit 600 during the charging-discharging of the batteries.

A signal generator 504 was used to generate the electromagnetic signals to be delivered to the batteries. Before injecting the signals to the batteries, a BCI circuit 600 was used to convert the electromagnetic signals to a bulk current (as detailed in FIG. 6), which was then injected into the battery.

The signal generator 504 was connected to an amplifier 506. The amplified signals entered the BCI circuit 600, and were then transmitted to a battery (i.e. shown as 604 in FIG. 6).

FIG. 6 details an exemplary BCI circuit 600. This circuit includes two capacitors 602, the battery 604, and the BCI probe 606.

In one embodiment, the setup 500 was placed inside a Faraday Cage to avoid electromagnetic interference. This cage is made of a wooden frame and metallic wires. Inside this cage, an oscilloscope 508 was used for monitoring the electromagnetic signals going through the batteries. FIG. 5 shows the oscilloscope 508 reading the signal between the amplifier 506 and the BCI circuit 600, however the oscilloscope was used to read signals at various locations.

After preparing the setup 500, several tests were conducted. One goal of this testing was to establish bulk current injection methods and protocols for inducing noise in batteries, and developing a circuit model for BCI testing.

For testing, CR 2032 coin cells experienced the effect of the BCI current. For testing, lithium iron phosphate was used as the primary cathode material which was mixed with a polymer binder of PVDF (Polyvinylidene fluoride) and a conductive agent of carbon black powders. Graphite was used as primary anode ingredient. The graphite was mixed with PVDF and carbon black to make a robust anode for the coil cells. A liquid electrolyte comprising lithium hexafluorophosphate (LiPF₆) in 1M Ethylene carbonate (EC) and Dimethyl carbonate (DMC) of 1:1 ratio, was utilized as an ionic transporting medium. To cycle the batteries, a voltage window of 2.8 V to 4.2 V was maintained.

The electromagnetic (EM) susceptibility of batteries and the characteristics of noise generated by a BCI probe were analyzed through impedance measurements of the BCI network. EMI measurements were performed on batteries using a 10 MHz sinusoidal signal from the signal generator 504. Multiple BCI signal routes were employed to cycle the batteries under varied conditions. Electromagnetic signal impacts were analyzed using the oscilloscope 508, with a specific emphasis on BCI current conversion through the circuit 600. Battery performance was assessed at different BCI input levels, and the thermal effects induced by BCI were studied and compared against non-BCI conditions. Throughout the battery cycling, in-situ temperature profiles were monitored, with solid-state electrolytes being employed for measurements. The thermal impact was observed using thermal sensors (RTD sensor) and a thermal camera, and a battery tester 510 was utilized to observe battery performance throughout the experimentation process.

### Example 2

In one experiment, the effects of variable frequency and input voltage to the battery were recorded. These parameters directly impacted battery performance. Output voltage, which was applied through the battery, was measured by the oscilloscope.

Graph 700A of FIG. 7A shows output voltage measured at different frequencies when the applied voltage was held (e.g., fixed) at 500 mV. It was clearly observed that the output voltage was increased with increasing the frequency while the input voltage maintained constant. The maximum output voltage was observed at 25 MHz.

Graph 700B of FIG. 7B shows the output voltage measured at different input voltages when the frequency was held (e.g., fixed) at 7.8 MHz. In this case, increased input voltage resulted in increasing the output voltage at a fixed frequency of 7.8 MHz. The maximum output voltage was achieved at 500 mV. The input voltage higher than 500 mV was not used due to the safety issue for the amplifier.

### Example 3

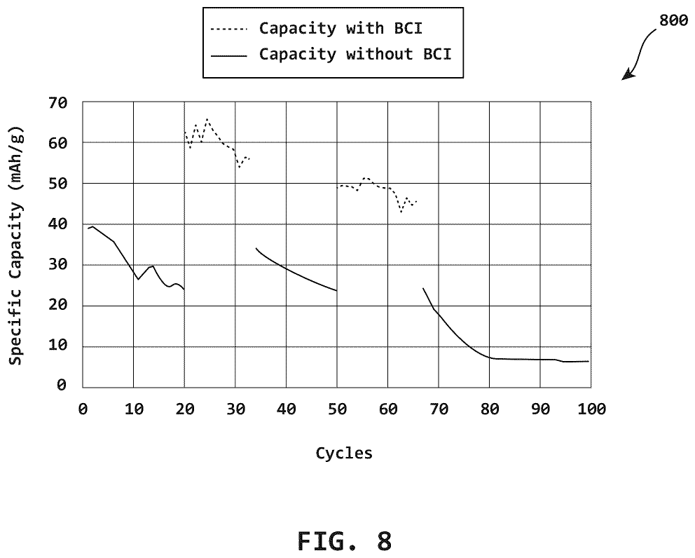

At FIG. 8, graph 800 shows specific capacity (mAh/g) as a function of charge-discharge cycles. The dashed lines represent cycles performed without BCI, while the solid lines represent cycles performed with BCI. The tests performed to yield the graph 800 were conducted under room temperature conditions (e.g., 65° F.-75° F.). Fast charging modalities (e.g., at a C-rate of 3 C) were used. This data shows that batteries charged using the BCI methods disclosed above (e.g., method 100 and/or method 200) retain higher specific capacity and exhibit reduced capacity fade over multiple cycles, confirming its ability to mitigate lithium plating and improve long-term cycle life.

### Example 4

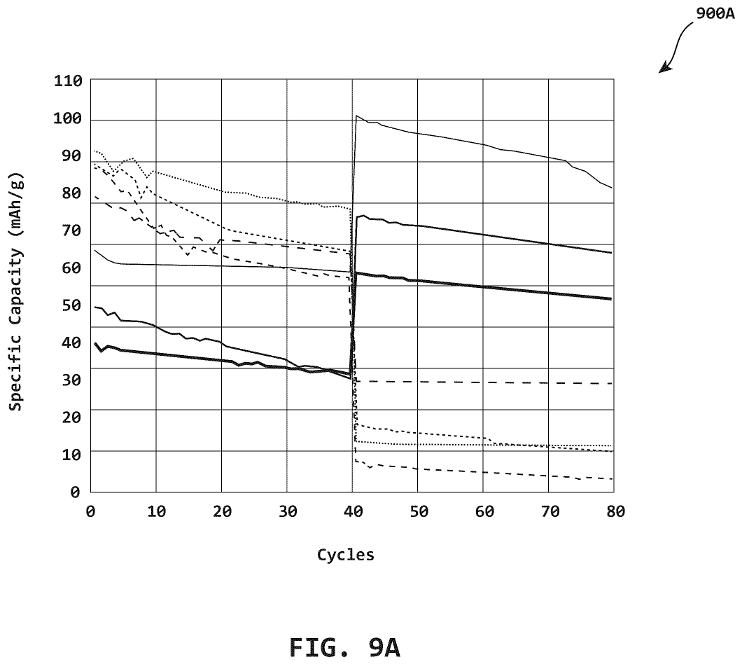

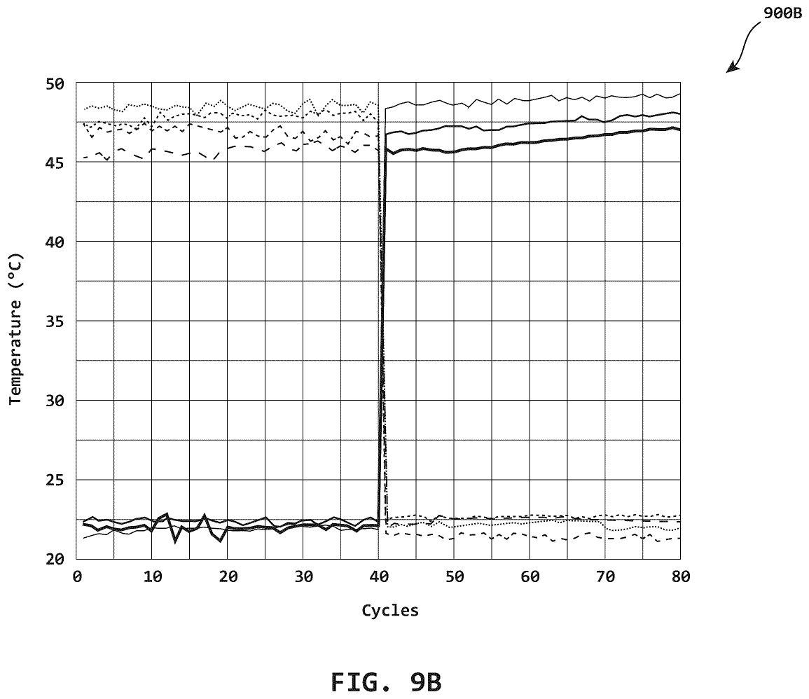

Referring now to FIG. 9A, graph 900A shows specific capacity (mAh/g) as a function of charge-discharge cycles. The test performed to yield graph 900A was similar to that of graph 800.

To observe the effect of a BCI signal, an input voltage of 500 mV and a frequency of 25 MHz were used to observe the battery performance over consecutive charges and discharges (e.g., cycles). A BCI was applied only while charging, replicating real life situations. Each of the seven cells shown were charged at 5 C current density and discharged at 1 C current density. The dashed lines indicate cells which were charged with BCI in the first 40 cycles and without BCI in the last 40 cycles. The solid lines indicate cells which were charged without BCI in the first 40 cycles and with BCI in the last 40 cycles.

From FIG. 9A, it can be seen that the cells with BCI experienced higher specific capacity, however the degradation of the capacity is significantly higher than the cells without BCI.

Referring to FIG. 9B, temperature changes across the cells used to produce graph 900A were also observed using a resistance temperature detector (RTD) and thermal camera, and are represented at graph 900B. Graph 900B shows temperature as a function of cycle number. It is clear that temperature increases more when BCI is applied than when it is not applied. Moreover, the different cells show different maximum temperatures across cycles. Critically, the elevated temperature generated from BCI enhanced the electrochemical performance of the battery. It is contemplated that this is a result of improved lithium-ion mobility within the cells.

### Example 5

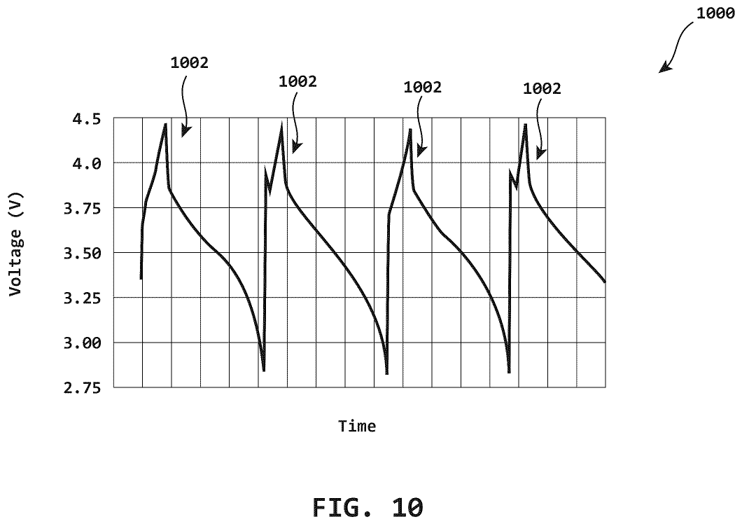

Referring to FIG. 10, voltage and capacity (Ah) are plotted as a function of time. In cold environments (−10° C.), BCI-treated batteries demonstrate stable charge/discharge behavior, while conventional batteries fail to operate or suffer significant performance degradation. The distinct voltage dip phenomenon during BCI application, indicated at reference number 1002 at FIG. 10, provides strong evidence of the electrochemical interactions induced by the AC signal, as well as justifying an elevated specific capacity due to an extended charge transfer period.

While the systems and methods above have been described and disclosed in certain terms and have disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A method of charging a lithium-ion battery, comprising:
providing a source of power comprising direct current to the lithium-ion battery, wherein providing the source of power increases a state-of-charge of the lithium-ion battery;
providing a bulk-current to the lithium-ion battery, wherein the bulk-current is an alternating current; and
charging the lithium-ion battery from a first state-of-charge level to a final state-of-charge level.

2. The method of claim 1, wherein providing the bulk-current comprises injection of the bulk-current to an anode of the lithium-ion battery for a period of about five minutes or less, about four minutes or less, about three minutes or less, about two minutes or less, about one minute or less, or about 30 seconds or less.

3. The method of claim 1, wherein the source of power is provided continuously to the battery.

4. The method of claim 1, wherein the source of power and/or the bulk-current are not provided continuously to the battery.

5. The method of claim 4, wherein providing the bulk-current comprises providing a plurality of injections of the bulk-current to an anode of the lithium-ion battery.

6. The method of claim 1, wherein the first state-of-charge level is about 90% or less and the final state-of-charge level is about 90% or greater, and wherein the battery is charged from the first state-of-charge level to the final state-of-charge level in less time than an identical method wherein a bulk-current is not provided to the lithium-ion battery.

7. The method of claim 1, wherein the first state-of-charge level is about 90% or less and the final state-of-charge level is about 90% or greater, and wherein, after the battery is charged from the first state-of-charge level to the final state-of-charge level, the battery comprises a lower concentration of lithium deposition at the anode of the battery than an identical method wherein a bulk-current is not provided to the lithium-ion battery.

8. The method of claim 1, wherein the bulk-current is provided to the lithium-ion battery when the lithium-ion battery is at a state-of-charge level of about 80% or greater, about 85% or greater, or about 90% or greater.

9. The method of claim 1, wherein the bulk-current is prepared by a bulk-current injection system comprising a signal generator and a power amplifier.

10. The method of claim 1, wherein the lithium-ion battery is an electric vehicle battery.

11. A method of charging a lithium-ion battery in a low-temperature environment, the method comprising:
providing the lithium-ion battery having a first state-of-charge level and a first temperature level;
providing a bulk-current to the lithium-ion battery to increase the temperature of the lithium-ion battery from the first temperature level to a second temperature level, wherein the bulk-current is an alternating current; and
providing a source of power comprising direct current to the lithium-ion battery, wherein providing the source of power increases the state-of-charge of the lithium-ion battery from a first state-of-charge level to a final state-of-charge level.

12. The method of claim 11, wherein the bulk-current increases the temperature of the lithium-ion battery from the first temperature level to the second temperature level via impedance heating from the battery's impedance, wherein the bulk-current is provided for a heating period that is a function of at least the first temperature level and the second temperature level, and wherein the heating period is determined by a battery management system comprising a processor.

13. The method of claim 11, further comprising providing a thermal maintenance bulk-current to maintain the lithium-ion battery temperature at a temperature of within about ±10° C. or less, about ±5° C. or less, about ±4° C. or less, about ±3° C. or less, about ±2° C. or less, or about ±1° C. or less of the second temperature level.

14. The method of claim 13, wherein the thermal maintenance bulk-current and the source of power are provided simultaneously.

15. The method of claim 11, wherein the first temperature level is about 0° C. or less, about −10° C. or less, about −20° C. or less, about −30° C. or less, or about −40° C. or less.

16. The method of claim 11, wherein the second temperature level is about 0° C. or greater, about 5° C. or greater, about 10° C. or greater, about 15° C. or greater, about 20° C. or greater, about 25° C. or greater, or about 30° C. or greater.

17. The method of claim 11, wherein the alternating current comprises a sinusoidal high-frequency current.

18. The method of claim 11, wherein the lithium-ion battery is an electric vehicle battery.

19. A lithium-ion battery charging system, comprising:
a lithium-ion battery having an anode and a cathode;
an alternating current power source configured to provide a bulk-current to the anode of the lithium-ion battery; and
a direct current power source configured to charge the battery from a first state-of-charge level to a final state-of-charge level.

20. The system of claim 19, wherein the system further comprises a battery management system configured to selectively engage and disengage the alternating current power source and/or the direct current power source during the charging.
